(19) United States
(12) Patent Application Publication
(10) Pub. No.: US 2013/0111800 A1
(43) Pub. Date: May 9, 2013

(54) WATERFOWL DECOY SUPPORT

(71) Applicants: MICHAEL D. PIFER, Louisville, KY (US); John M. Moore, Louisville, KY (US)

(72) Inventors: MICHAEL D. PIFER, Louisville, KY (US); John M. Moore, Louisville, KY (US)

(21) Appl. No.: 13/292,830

(22) Filed: Nov. 9, 2011

(51) Int. Cl. A01M 31/06

(52) U.S. Cl. 43/3

(57) ABSTRACT

The waterfowl decoy support is formed of a length of stiff rod configured to support a ballasted flotation-type decoy above a land or water surface. The decoy support may have an elongated upper slot adapted to slide over the keel of the ballast weight of the decoy, or may have an upper support arm extending from the upper end of the rod, the uppermost end of the arm terminating in an eye. The eye provides a non-rigid connection to an eyebolt or the like secured to the back of the decoy, allowing the decoy to move in the wind. The lower end of the rod either may have a spike for insertion into the ground or a generally horizontal loop for placement on the surface of the ground.

### BACKGROUND OF THE INVENTION

1. Field of the Invention

The present invention relates generally to hunting decoys, and particularly to a waterfowl decoy support configured to attach removably to a buoyant waterfowl decoy in order to support the decoy either on land or in a shallow body of water.

2. Description of the Related Art

Realistic hunting decoys are relatively costly, but they are necessary accessories for many types of hunting. An example of such is found in the field of waterfowl hunting, i.e., ducks and geese. Such amphibious game fowl may be found on the surface of a body of water or on land, and the successful hunter will require a number of high quality decoys adapted to each environment. This means that the hunter needs one set of decoys having supports for placement on land and a separate second set of decoys adapted for flotation on a body of water, thus increasing the cost of participating in the sport by a significant amount.

Flotation decoys are specialized devices, in that they are provided with ballasted keels to keep them floating upright. The keels extend from beneath the decoy, and generally have some means of attaching an anchor line or the like as well. Thus a flotation type decoy is not adapted for placement on land, as the keel does not allow the decoy to sit upright when placed upon a solid surface. Decoys adapted for use on land do not have the ballasted keel of a flotation type decoy and thus do not remain upright to present a realistic appearance when placed upon a body of water, and may not even be capable of remaining afloat on the water.

Thus, a waterfowl decoy support solving the aforementioned problems is desired.

### SUMMARY OF THE INVENTION

The waterfowl decoy support supports a waterfowl decoy having a ballasted keel either over a body of water or on land. Each of the decoy support embodiments is formed of a length of stiff, heavy gauge wire or rod having a square, round, or other cross-sectional shape.

Various embodiments of the decoy support each include an upper portion bent to form a relatively long and narrow slot. The slot is adapted to slide removably over the stem of the ballast keel beneath the decoy and to grip the stem therein. A support rod or strut extends from the upper portion, the rod or strut being disposed substantially beneath the longitudinal center of the slot for proper balance of the decoy. The lower end of the support strut provides an interface with the underlying surface, comprising either a spike for driving into the solid surface or a loop of square, circular, or other planform, with the plane of the loop being generally normal to and centered about the axis of the support strut or rod.

Other embodiments of the decoy each have a support arm extending upwardly and outwardly from the upper end of the support rod or strut. The support arm curves back over the support rod or strut and terminates in a decoy attachment eye spaced above the support rod. The attachment eye provides attachment to the back of the decoy by means of an eye screw or the like, which is threaded into the back of the decoy, thus allowing the decoy to sway and move slightly in any breeze that may occur. The lower end of the support strut may comprise either a spike or a square, circular, or other shaped loop, as in the case of the first embodiments of the decoy support. The decoy attachment eye is disposed above the plane of the loop.

These and other features of the present invention will become readily apparent upon further review of the following specification and drawings.

### BRIEF DESCRIPTION OF THE DRAWINGS

FIG. 1 is an environmental, perspective view showing a plurality of waterfowl decoys deployed upon a land surface and over a body of water, each of the decoys being supported by a waterfowl decoy support according to the present invention.

FIG. 2 is an exploded perspective view of a first embodiment of a waterfowl decoy support according to the present invention, showing the manner of attaching the decoy to the support.

FIG. 3 is an exploded perspective view of a second embodiment of a waterfowl decoy support according to the present invention, shown in a manner similar to FIG. 2.

FIG. 4 is a perspective view of a third embodiment of a waterfowl decoy support according to the present invention.

FIG. 5 is a perspective view of a fourth embodiment of a waterfowl decoy support according to the present invention.

FIG. 6 is a perspective view of a fifth embodiment of a waterfowl decoy support according to the present invention.

FIG. 7 is a perspective view of a sixth embodiment of a waterfowl decoy support according to the present invention.

Similar reference characters denote corresponding features consistently throughout the attached drawings.

### DETAILED DESCRIPTION OF THE PREFERRED EMBODIMENTS

The waterfowl decoy support enables flotation-type decoys to be deployed either upon or over the surface of a body of water, or upon a land surface. Various embodiments of the decoy support are disclosed, each of the supports being formed of a single length of stiff and rigid metal rod or wire of any practicable cross-sectional shape.

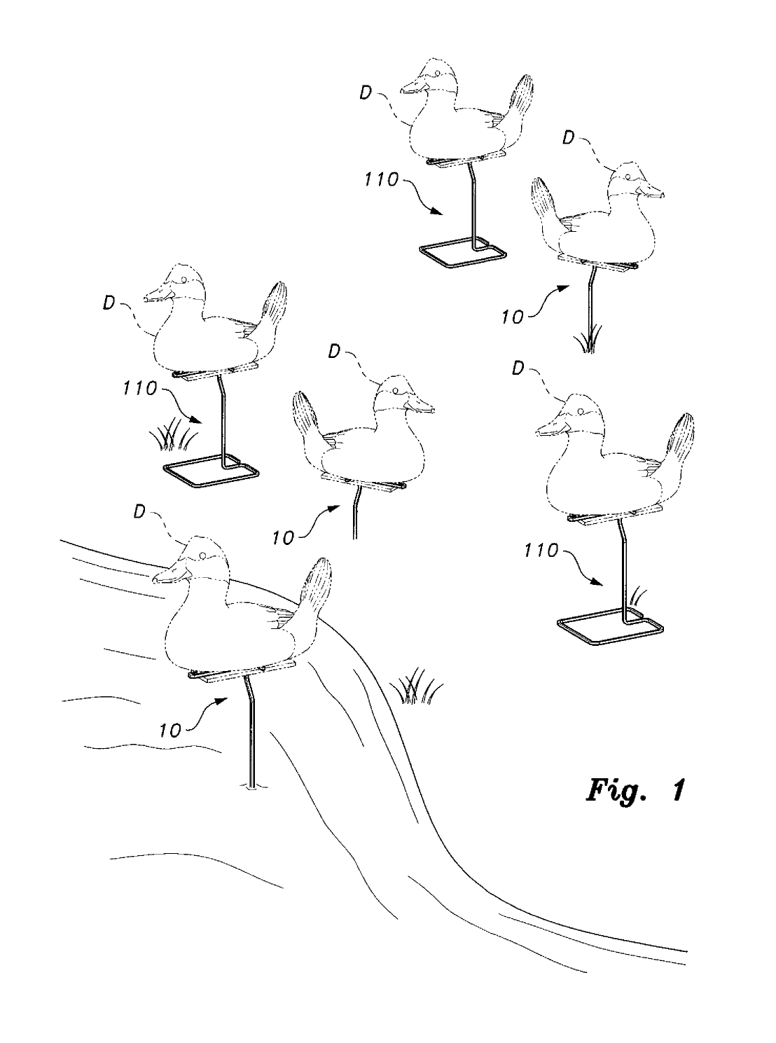

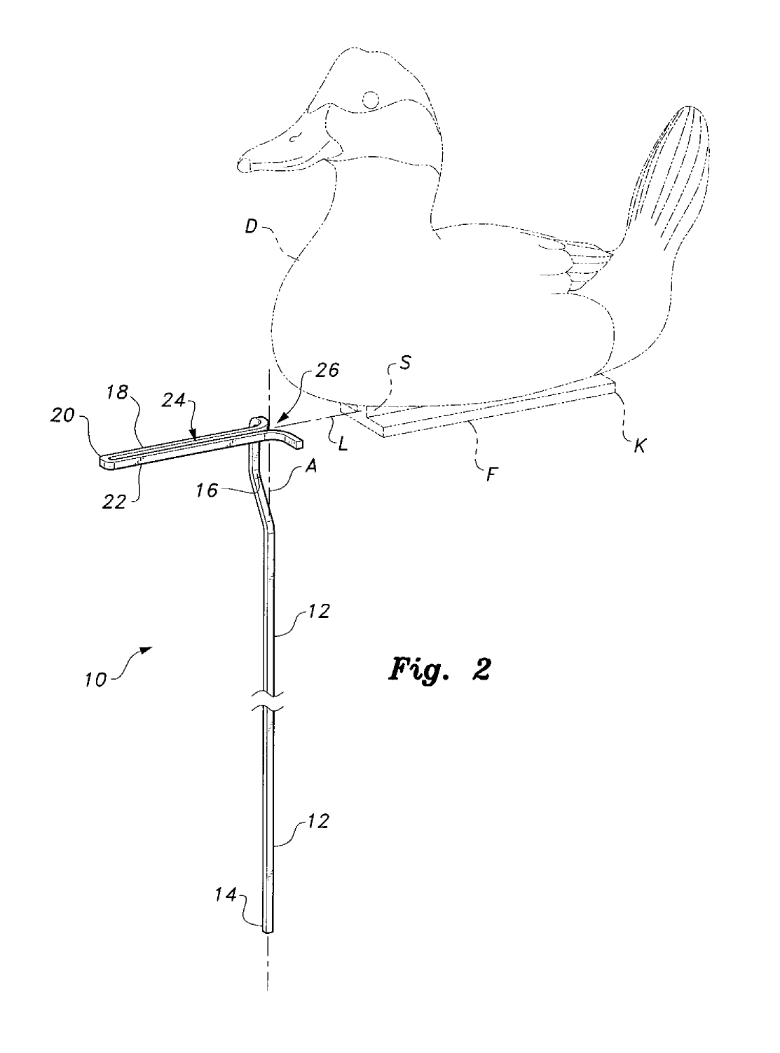

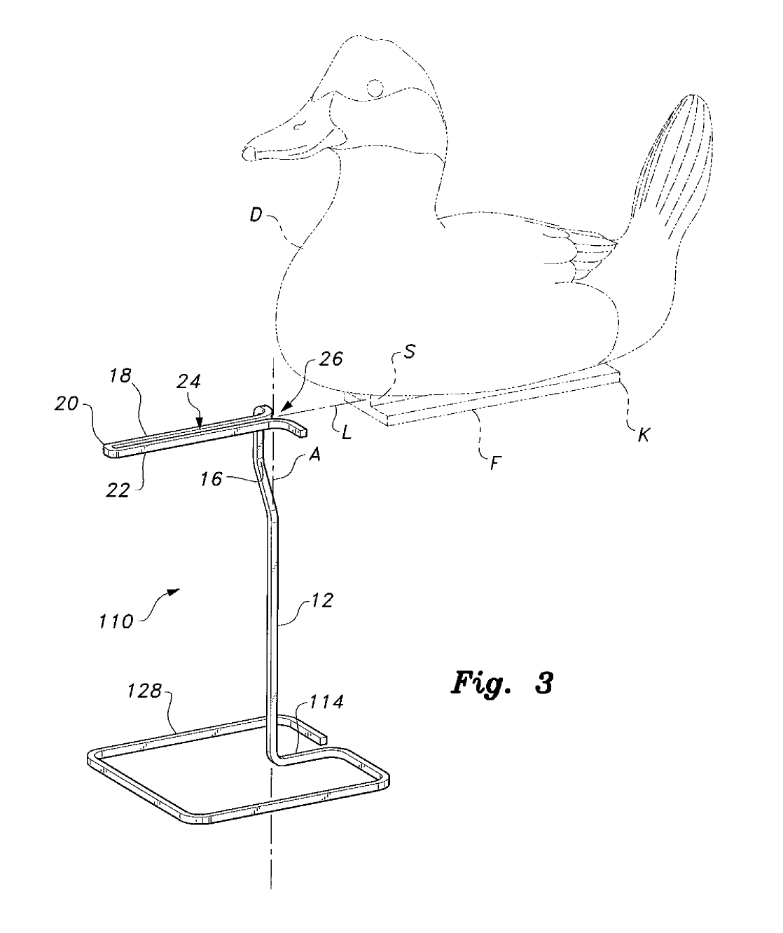

FIG. 1 of the drawings is an environmental perspective view showing both first and second embodiments of the waterfowl decoy supports, designated generally as 10 and 110, respectively, deployed in the field. Each of the decoy supports 10, 110 is shown supporting a flotation-type waterfowl decoy D (e.g., a duck, or other waterfowl species alternatively) thereon. The two types or embodiments of decoy supports 10, 110 illustrated in FIG. 1 are shown in detail respectively in FIGS. 2 and 3. The only difference between the embodiments of the decoy supports 10 and 110 of FIGS. 2 and 3 and those illustrated in FIG. 1 is that the decoy supports shown in FIG. 1 are each formed of a single, unitary length of wire or rod having a round cross section, while the decoy embodiments illustrated in FIGS. 2 and 3 are formed of a single length of wire or rod having a square cross section.

The decoy support 10 illustrated in detail in FIG. 2 includes an elongate, stiff rod portion 12 having a base end 14 and an opposite decoy attachment end 16. The rod portion 12 defines an elongate axis A. The rod portion 12 may be of any practicable length. The base end 14 terminates in a ground penetration spike. The base end may be sharpened, if desired. It will be seen that the decoy attachment end portion 16 of the rod 12 is laterally offset from the rod axis A. An elongate first grip member 18 extends from the offset decoy attachment end 16. The first grip member 18 has a 180° bend in its distal end 20. An elongate second grip member 22 extends back from the distal end 20 of the first grip member 18 to lie laterally opposite and parallel to the first grip member. The two grip members 18 and 22 define a decoy keel gripping slot 24 therebetween, the slot 24 having a longitudinal axis L. The laterally offset decoy attachment end portion 16 of the rod 12 results in the longitudinal axis L of the decoy keel gripping slot 24 being coplanar with the axis A of the rod portion 12, the two axes A and L being substantially normal to one another.

Flotation type decoys D are conventionally provided with a longitudinally disposed ballast keel K extending therebeneath. The keel K has an inverted T cross section with a stem S and a laterally symmetrical flange F extending across the lower end of the stem normal thereto, generally as shown in FIGS. 2 through 5 of the drawings. The two ends of the first and second grip members 18 and 22 that are opposite the distal end 20 of the first member that connects to the second member define a throat 26 into which the stem S of the decoy ballast keel K is inserted. The stem S is advanced through the slot 24 of the decoy support 10 until it is stopped by the closed distal end 20 of the grip members 18 and 22 so that the grip members 18 and 22 bear against the sides of the keel stem S to secure the decoy D to the support 10. The decoy D cannot be lifted from the slot 24 due to the wider flange F of the keel K, which extends laterally below each of the grip members 18 and 22. The lateral offset of the upper portion 16 of the rod 12 provides clearance for the flange F of the ballast keel. The decoy D may be installed upon the support 10 to face in either direction, and is not limited to the orientation illustrated in FIG. 2.

FIG. 3 of the drawings illustrates a second embodiment of the decoy support, designated as support 110. The support 110 is substantially identical to the support 10 of FIG. 2 excepting for the base, with identical components sharing identical reference numerals. The base end 114 of the decoy support 110 is bent normal to the axis A of the rod 12 is formed into a support loop 128 having a square or rectangular periphery, being formed integrally with the rod 12 as a continuous extension thereof. The support loop 128 defines a plane that is substantially normal to the axis A of the rod 12. The offset provided by the base end 114 of the rod 12 results in the axis A of the rod 12 penetrating the general center of the plane of the support loop 128. The decoy support 110 of FIG. 3 allows the support 110 and its decoy D to be placed upon firmer surfaces without the need to penetrate the surface, as would be the case with the first embodiment of the decoy support 10.

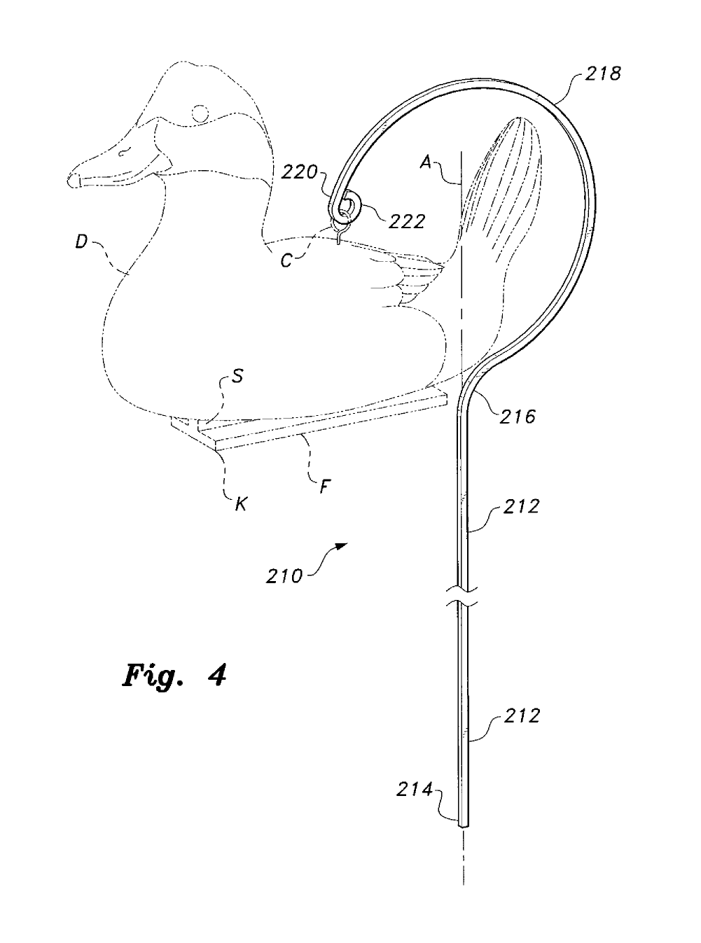

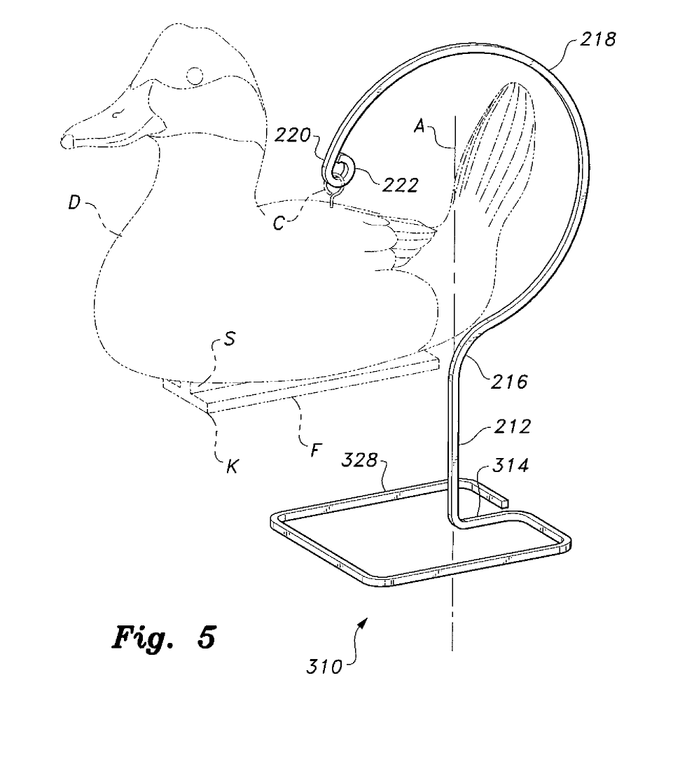

FIGS. 4 and 5 illustrate two additional embodiments of the decoy support, respectively designated as decoy support 210 (FIG. 4) and 310 (FIG. 5). The decoy support 210 of FIG. 4 has an elongate, stiff support rod 312 substantially identical to the support rod 12 of the decoy support 10 of FIG. 2, i.e., having an elongate axis A and a base end 214 terminating in a ground penetration spike. While the base end 214 may be blunt, as shown, preferably the end is sharpened to facilitate ground penetration in firmer ground.

The opposite decoy attachment end 216 of the rod 210 has an arcuate decoy suspension arm 218 extending generally upwardly therefrom, with the suspension arm 218 terminating in a distal end 220. A decoy attachment eye 222 is formed in the distal end 220 of the suspension arm 218. The arcuate curve of the suspension arm 218 is sufficiently large to provide clearance for a waterfowl decoy D suspended from the attachment eye 222. The decoy D has a support attachment eye or component C (e.g., an eye screw, etc.) extending from its back, and is removably connected to the eye 222 of the suspension arm 218 of the support 212. (The decoy attachment eye 222 of the decoy support 210 may have a slight gap therein, as shown in FIG. 4, to allow the support attachment eye or component C of the decoy D to pass therethrough to install and remove the decoy D from the support 210.)

The movable link provided by the attachment component or eye C and the suspension arm eye 222 allows the decoy D to swing and move in any breeze that might occur, thus adding further realism to the decoy D. A conventional swivel or the like, e.g., fishing leader swivel, etc., may be installed between the support attachment component or eye C of the decoy D and the suspension arm eye 220, if desired, to allow the decoy to pivot or revolve through 360°. While the suspension arm 218 is visible above a portion of the decoy D, its relatively thin structure results in its not being readily apparent. Additional concealment may be provided by covering it in a camouflage color or pattern (e.g., weeds, reeds, etc.) to provide a more natural appearance.

FIG. 5 of the drawings illustrates a fourth embodiment of the decoy support, designated as support 310. The support 310 is substantially identical to the support 210 of FIG. 4, excepting for the base, with identical components sharing identical reference numerals. The base end 314 of the decoy support 310 is bent normal to the axis A of the rod 212 and extends to a support loop 328 having a square or rectangular periphery, which is formed integrally with the rod 212 as a continuous extension thereof. The support loop 328 defines a plane that is substantially normal to the axis A of the rod 212. The offset provided by the base end 314 of the rod 212 results in the axis A of the rod 212 penetrating the general center of the plane of the support loop 328. The decoy support 310 of FIG. 5 allows the support 310 and its decoy D to be placed upon firmer surfaces without the need to penetrate the surface, as would be the case with the decoy support 210.

As in the case of the other embodiments described further above, the decoy support 310 of FIG. 5 may be provided in combination with a waterfowl decoy, if desired. The various decoy supports described herein provide much greater versatility for flotation-type decoys, enabling them to be used conventionally on the surface of a body of water or to be supported by means of any of the embodiments of FIGS. 1 through 5. While the various decoy support embodiments described herein are particularly well suited for the deployment of flotation-type decoys on land, it should be noted that they may also be placed in shallow water, if desired, as shown by one of the decoys and supports in the environmental view of FIG. 1. It should also be noted that while the embodiments of FIGS. 4 and 5 show flotation type decoys having ballast keels, the attachment of the decoy to the support by a fitting or component attached to the back of the decoy allows other types of decoys to be used with such supports, if desired.

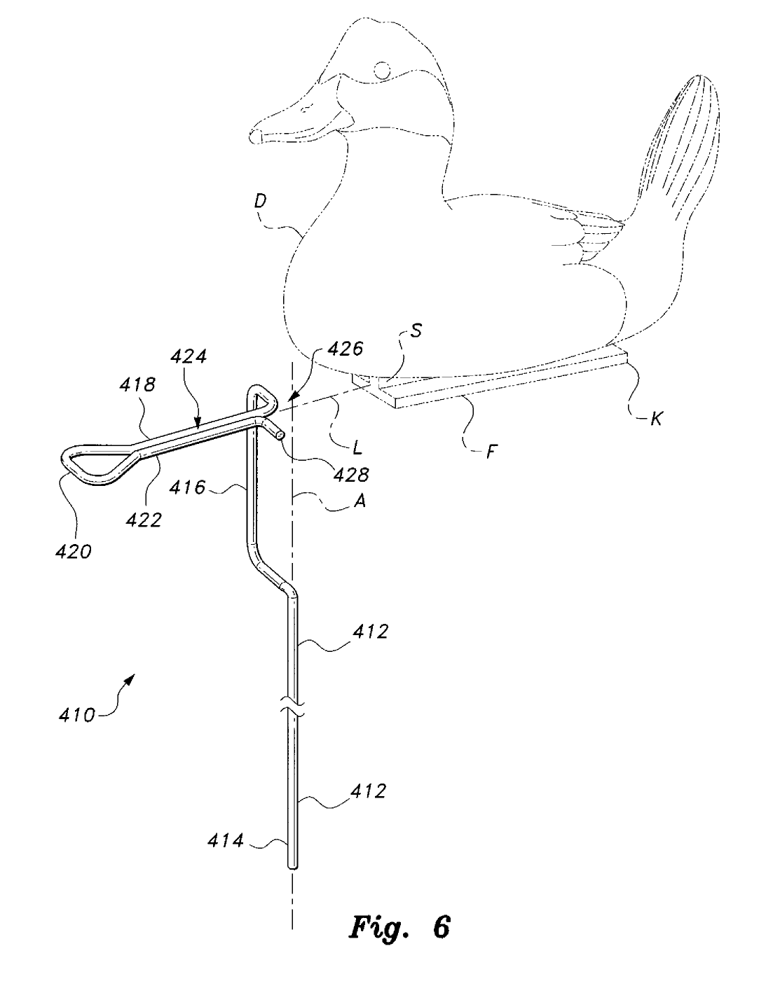

FIG. 6 of the drawings illustrates a fifth embodiment of the decoy support, designated as decoy support 410. The decoy support 410, illustrated in detail in FIG. 6, includes an elongate, stiff rod portion 412 having a round cross-section defining a base end 414 and an opposite decoy attachment end 416, similar to the corresponding components of the first embodiment decoy support 10 of FIG. 2. The rod portion 412 defines an elongate axis A. The rod portion 412 may be of any practicable length. The base end 414 terminates in a ground penetration spike. The base end 414 may be sharpened, if desired. It will be seen that the decoy attachment end portion 416 of the rod 412 is laterally offset from the rod axis A by a lateral bend of substantially 90°, rather than the shallower bend of approximately 30° used in other embodiments.

An elongate first grip member 418 extends from the offset decoy attachment end 416. The first grip member 418 has a generally triangular loop resulting in a 180° bend in its distal end 420. This loop forming the 180° bend in the distal end 420 may have some other regular or irregular geometric shape, if desired. An elongate second grip member 422 extends back from the distal end loop 420 of the first grip member 418 to lie laterally opposite and parallel to the first grip member. The two grip members 418 and 422 define a decoy keel gripping slot 424 therebetween, the slot 424 having a longitudinal axis L. The laterally offset decoy attachment end portion 416 of the rod 412 results in the longitudinal axis L of the decoy keel gripping slot 424 being coplanar with the axis A of the rod portion 412, the two axes A and L being substantially normal to one another.

The two ends of the first and second grip members 418 and 422 that are opposite the distal end loop 420 connecting the first member 418 to the second member 422 define a throat 426 into which the stem S of the decoy ballast keel K is inserted, as in the case of the other decoy support embodiments of FIGS. 1 through 3. The terminating end 428 of the second grip member 422 is bent outwardly opposite its counterpart component between the decoy attachment end portion 416 and the first grip member 428, as in the other embodiments of FIGS. 1 through 3. However, it will be noted that this terminating end 428 is staggered or offset toward the loop end 420 of the grip members 418 and 422, rather than being aligned with its counterpart component as in the embodiments of FIGS. 1 through 3.

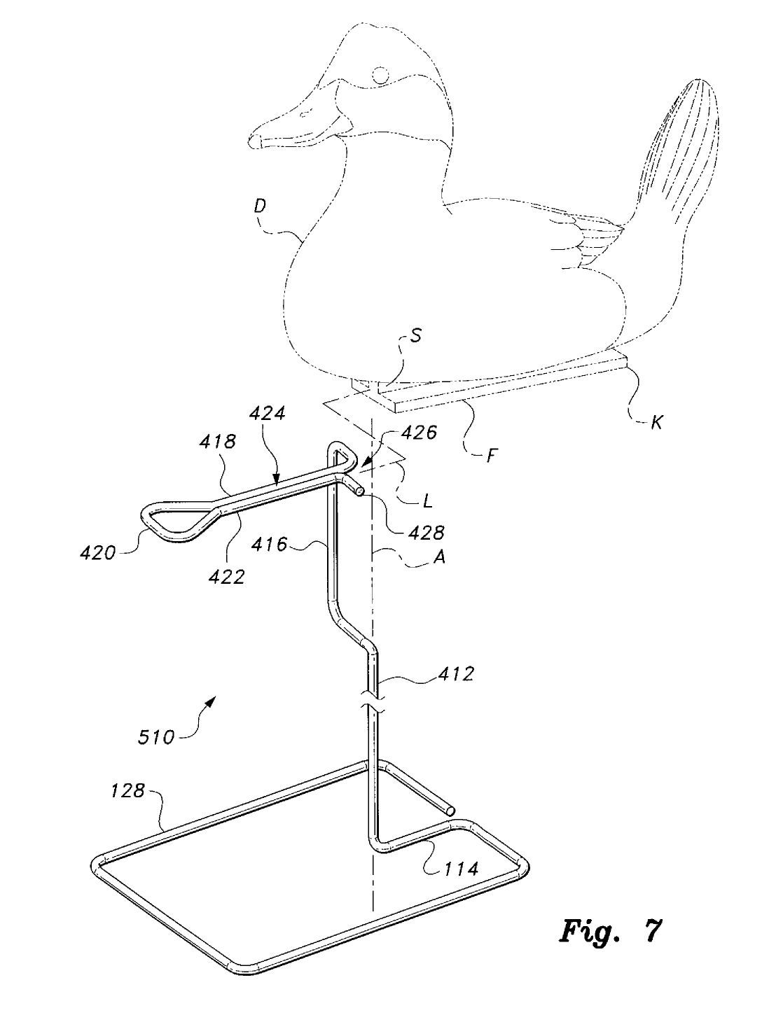

FIG. 7 of the drawings illustrates a sixth embodiment of the decoy support, designated as support 510. The support 510 is substantially identical to the support 410 of FIG. 5, except for the base, and is shown with identical reference numerals being used to designate those components and features identical to the support 410 of FIG. 5. However, the base is configured substantially identical to the base of the second embodiment decoy support 110 of FIG. 3, and is shown with like reference numerals to those used to designate components of the base of the decoy support 110 of FIG. 3 being used to designate like components of the base of the decoy support 510 of FIG. 7. The decoy support 510 of FIG. 7 is preferably formed of a length of rigid rod having a round cross-section, as in the case of the decoy support 410 of FIG. 6.

The base end 114 of the decoy support 510 is bent normal to the axis A of the rod 412 and is formed into a support loop 128 having a square or rectangular periphery, being formed integrally with the rod 412 as a continuous extension thereof. The support loop 128 defines a plane that is substantially normal to the axis A of the rod 412. The offset provided by the base end 114 of the rod 412 results in the axis A of the rod 412 penetrating the general center of the plane of the support loop 128. The decoy support 510 of FIG. 6 allows the support 510 and its decoy D to be placed upon firmer surfaces without the need to penetrate the surface, as would be the case with the first embodiment of the decoy supports 10, 210, and 410, respectively of FIGS. 2, 4, and 6.

Each of the waterfowl decoy support embodiments is formed of a single, unitary length of stiff rod or the like having either a round, rectangular, or other cross-section, with such material being relatively inexpensive. The dies, tooling, and/or other fixtures that may be used to form the shapes of the waterfowl decoy supports enable the various embodiments to be manufactured quickly and easily. As a result, the waterfowl decoy support in any of its various embodiments is relatively inexpensive to manufacture, enabling sellers of the device to set a reasonably economical price for the device. The hunter or other person requiring a number of waterfowl decoy supports for use with a corresponding number of decoys, may readily purchase the required number of supports without undue financial hardship due to the relatively low cost of the devices, particularly in comparison to other decoy accessories of the prior art and the preclusion of need of an additional set of decoys configured strictly for land use.

It is to be understood that the present invention is not limited to the embodiments described above, but encompasses any and all embodiments within the scope of the following claims.

We claim:

1. A waterfowl decoy support, comprising:
an elongate rod having a base end, a decoy attachment end opposite the base end, and an elongate axis;
an elongate first grip member extending from the decoy attachment end of the rod, the first grip member having a distal end; and
an elongate second grip member extending from the distal end of the first grip member, the second grip member being opposite and substantially parallel to the first grip member, the first grip member and the second grip member defining a decoy keel gripping slot therebetween, the slot having a longitudinal axis.

2. The waterfowl decoy support according to claim 1 further including a flotation waterfowl decoy in combination therewith, the decoy having a ballast keel stem and a ballast flange extending laterally from and normal to the stem, the stem being removably inserted in the slot and the flange below the grip members to retain the decoy on the support.

3. The waterfowl decoy support according to claim 1, wherein the base end of the rod terminates in a ground penetration spike.

4. The waterfowl decoy support according to claim 1, further including a support loop extending from the base end of the rod, the support loop defining a plane, the plane being substantially normal to the axis of the rod and parallel to the longitudinal axis of the decoy keel gripping slot.

5. The waterfowl decoy support according to claim 1, wherein the axis of the rod is coplanar with the longitudinal axis of the decoy keel gripping slot and substantially normal thereto.

6. The waterfowl decoy support according to claim 1, wherein the rod, the first grip member, the second grip member, and the base end of the rod are formed as a single, unitary length of material having a square cross section.

7. The waterfowl decoy support according to claim 1, wherein the rod, the first grip member, the second grip member, and the base end of the rod are formed as a single, unitary length of material having a round cross section.

8. A waterfowl decoy support, comprising:
an elongate rod having a base end, a decoy attachment end opposite the base end, and an elongate axis;
a decoy suspension arm extending arcuately from the decoy attachment end of the rod, the arm having a distal end; and
a decoy attachment eye disposed at the distal end of the arm.

9. The waterfowl decoy support according to claim 8, further including a waterfowl decoy in combination therewith, the decoy having a support attachment eye extending therefrom, the support attachment eye being removably and non-rigidly attached to the decoy attachment eye.

10. The waterfowl decoy support according to claim 8, wherein the base end of the rod terminates in a ground penetration spike.

11. The waterfowl decoy support according to claim 8, further including a support loop extending from the base end of the rod, the support loop defining a plane, the plane being substantially normal to the axis of the rod.

12. The waterfowl decoy support according to claim 8, wherein the rod, the arm, and the base end of the rod are formed as a single, unitary length of material having a square cross section.

13. The waterfowl decoy support according to claim 8, wherein the rod, the arm, and the base end of the rod are formed as a single, unitary length of material having a round cross section.

14. A waterfowl decoy support and waterfowl decoy, comprising in combination:
an elongate rod having a base end, a decoy attachment end opposite the base end, and an elongate axis;
s an elongate first grip member extending from the decoy attachment end of the rod, the first grip member having a distal end;
an elongate second grip member extending from the distal end of the first grip member, the second grip member being opposite and substantially parallel to the first grip member, the first grip member and the second grip member defining a decoy keel gripping slot therebetween, the slot having a longitudinal axis; and
a flotation waterfowl decoy, the decoy having a ballast keel stem and a ballast flange extending laterally from and normal to the stem, the stem being removably inserted in the slot and the flange below the gripping members to retain the decoy on the support.

15. The waterfowl decoy support and waterfowl decoy combination according to claim 14, wherein the base end of the rod terminates in a ground penetration spike.

16. The waterfowl decoy support and waterfowl decoy combination according to claim 14, further including a support loop extending from the base end of the rod, the support loop defining a plane, the plane being substantially normal to the axis of the rod and parallel to the longitudinal axis of the decoy keel gripping slot.

17. The waterfowl decoy support and waterfowl decoy combination according to claim 14, wherein the axis of the rod is coplanar with the longitudinal axis of the decoy keel gripping slot and substantially normal thereto.

18. The waterfowl decoy support and waterfowl decoy combination according to claim 14, wherein the rod, the first grip member, the second grip member, and the base end of the rod are formed as a single, unitary length of material having a square cross section.

19. The waterfowl decoy support and waterfowl decoy combination according to claim 14, wherein the rod, the first grip member, the second grip member, and the base end of the rod are formed as a single, unitary length of material having a round cross section.
